(19) United States
(12) Patent Application Publication
(10) Pub. No.: US 2019/0368874 A1
(43) Pub. Date: Dec. 5, 2019

(54) CHAINSAW LEVEL APPARATUS

(71) Applicant: Randolph E. Gooner, Georgetown, DE (US)

(72) Inventor: Randolph E. Gooner, Georgetown, DE (US)

(21) Appl. No.: 15/994,319

(22) Filed: May 31, 2018

(51) Int. Cl. G01C 9/36; G01C 9/28; B27B 17/00

(52) U.S. Cl. CPC G01C 9/36; B27B 17/0083; G01C 9/28

(57) ABSTRACT

A level apparatus for chainsaws is provided. The level apparatus can be adhered to pre-existing chainsaws for indicating when a user is keeping the chainsaw level through a cut. The level apparatus may include a transparent vial defined by a curved portion and a planar portion engaging the curved portion at least along its periphery so that a fluid be may encased between the curved and planar portion. The fluid may accommodate a bubble so that when the vial is in a level state the bubble occupies the center of the curved portion, and wherein a non-level state the bubble slides along the curved portion accordingly, thereby indicating to the user that the level apparatus is not level.

### BACKGROUND OF THE INVENTION

The present invention relates to level apparatuses and, more particularly, to a level apparatus for chainsaws.

When chainsaw users flush cut a stump when cutting a tree down, it is hard to make the chainsaw saw stay at a level angle through the bottom cut. By keeping the chainsaw level the user can cut all the way around the stump and stay within the same cut of the tree.

As can be seen, there is a need for a level apparatus for chainsaws.

### SUMMARY OF THE INVENTION

In one aspect of the present invention, a chainsaw level apparatus includes a vial having a planar portion and a transparent or translucent curved portion, the planar portion engaging at least a periphery of the curved portion; and a fluid encased a vial cavity defined by the curved and planar portions.

In another aspect of the present invention, the chainsaw level apparatus includes a vial having a planar portion and a transparent or translucent curved portion, the planar portion engaging at least a periphery of the curved portion; a fluid encased a vial cavity defined by the curved and planar portions; a bubble accommodated by said fluid; a center marking at a center of a curvature of the curved portion; and an adhesive layer provided along the planar portion beyond the periphery of the curved portion.

In yet another aspect of the present invention, a method of indicating that a chainsaw blade is in a horizontal orientation during use includes the steps of providing the above-mentioned chainsaw level apparatus and adhering said chainsaw level apparatus via the adhesive layer to a portion of the chainsaw that is coplanar with said chainsaw blade so that during use the user can determine if the bubble is resting near the center marking.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an elevational view of an exemplary embodiment of the present invention;

FIG. 3 is a detailed enlarged elevational view of an exemplary embodiment of the present invention.

FIG. 4 is a sectional view of an exemplary embodiment of the present invention, taken along line 4-4 in FIG. 3;

FIG. 5 is an elevational view of an exemplary embodiment of the present invention, shown in use;

FIG. 6 is an alternative section view of FIG. 4 of an exemplary embodiment of the present invention, demonstrating an adhesive layer for retrofitting purposes;

and

FIG. 7 is an enlarged detail view of FIG. 6 of an exemplary embodiment of the present invention, further illustrating the adhesive layer.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a level apparatus for chainsaws that can be adhered to pre-existing chainsaws for indicating when a user is keeping the chainsaw level through a cut. The level apparatus may include a transparent vial defined by a curved portion and a planar portion engaging the curved portion along its periphery so that a fluid be may encased between the curved and planar portion. The fluid may accommodate a bubble that in a level state occupies the marked center of the curved portion, and wherein a non-level state the bubble slides along the inner portion of the curved portion accordingly, thereby indicating to the user that the level apparatus is not level.

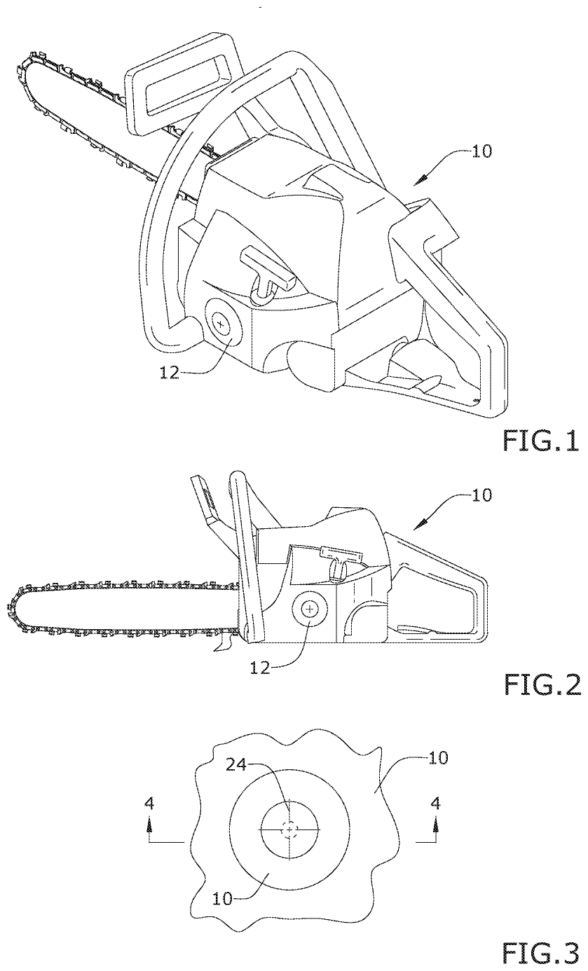

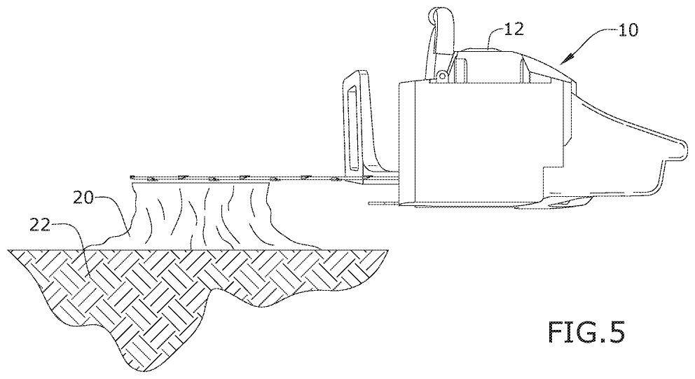

Referring to FIGS. 1 through 7, the present invention may include a level apparatus 12 for a chainsaw 10. The level apparatus 12 is adapted to indicate whether a surface is horizontal (level) or vertical (plumb), and in certain embodiments whether the blade of the chainsaw 10 is parallel to the ground 22 when cutting a tree stump 20

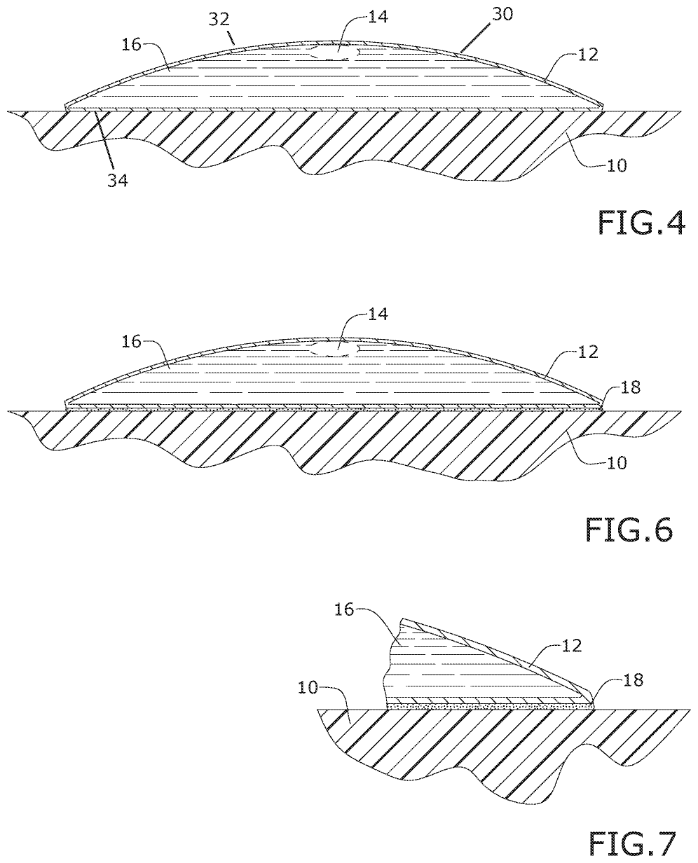

The level apparatus 12 may include a slightly curved transparent vial 30 with constant inner diameter at each viewing point. The vial 30 may have a curved portion 34 and an interconnecting planar rear portion 32 defining a vial cavity. The vial cavity may be incompletely filled with a fluid 16, such as alcohol or the like, leaving a bubble 14 in the encased fluid 16. As seen in FIGS. 4 and 6, the upward curvature of the curved portion 32 urges the bubble 14 to naturally rest in the center, the highest point, when the planar portion 34 is horizontal (normal to the direction of gravity). At slight inclinations—i.e., where the planar portion 34 moves from normal to the direction of gravity, the bubble 14 travels away from the marked center position 24 of the curved portion 32. As a result, such inclinations are indicated for the user of the chainsaw 10 to selectively make adjustments accordingly. The level apparatus 12 may also be usable upside-down or on its side.

In certain embodiments, the level apparatus 12 may provide an adhesive layer 18 along an outer portion of the planar portion 34 so that the level apparatus 12 may be retrofitted (affixed) to a pre-existing chainsaw 10.

A method of using the present invention may include the following. The level apparatus 12 disclosed above may be provided. A user may attach said level apparatus 12 to a side of a chainsaw 10, enabling the user to keep the chainsaw 10 at a perfectly level position when cutting a tree 20.

Additionally, the level apparatus 12 can be used on any tools that needs to be applied on a level basis.

It should be understood, of course, that the foregoing relates to exemplary embodiments of the invention and that modifications may be made without departing from the spirit and scope of the invention as set forth in the following claims.

What is claimed is:

1. A chainsaw level apparatus, comprising:
a vial having a planar portion and a transparent or translucent curved portion, the planar portion engaging at least a periphery of the curved portion; and
a fluid encased a vial cavity defined by the curved and planar portions.

2. The chainsaw level apparatus of claim 1, further comprising:
a bubble accommodated by said fluid.

3. The chainsaw level apparatus of claim 1, further comprising:
a center marking at a center of a curvature of the curved portion.

4. The chainsaw level apparatus of claim 1, further comprising:
an adhesive layer provided along the planar portion beyond the periphery of the curved portion.

5. A chainsaw level apparatus, comprising:
a vial having a planar portion and a transparent or translucent curved portion, the planar portion engaging at least a periphery of the curved portion;
a fluid encased a vial cavity defined by the curved and planar portions;
a bubble accommodated by said fluid;
a center marking at a center of a curvature of the curved portion; and
an adhesive layer provided along the planar portion beyond the periphery of the curved portion.

6. A method of indicating that a chainsaw blade is in a horizontal orientation during use, comprising the steps of:
providing a chainsaw level apparatus of claim 5; and
adhering said chainsaw level apparatus of claim 5, via the adhesive layer, to a portion of the chainsaw that is coplanar with said chainsaw blade.

7. The method of claim 6, further comprising the step of monitoring said chainsaw level apparatus of claim 5 during use to determine if the bubble is resting near the center marking.
